(19) United States
(12) Patent Application Publication
(10) Pub. No.: US 2006/0187407 A1
(43) Pub. Date: Aug. 24, 2006

(54) Spectacles and sunshade clip assembly having multi-layered hinges

(76) Inventors: Suk-Jae Lee, Daegu (KR); Ju-Jae Lee, Daegu (KR); Hyun-Jun Lee, Daegu (KR); Sung-Jun Lee, Deagu (KR)

Correspondence Address: MAYER, BROWN, ROWE & MAW LLP, 1909 K STREET, N.W., WASHINGTON, DC, 20006, US

(21) Appl. No.: 11/060,786

(22) Filed: Feb. 18, 2005

(51) Int. Cl. G02C 9/00

(52) U.S. Cl. 351/47

(57) ABSTRACT

Disclosed herein is a spectacles and sunshade clip assembly. The assembly comprises spectacles including a pair of lens frames connected to each other by means of a bridge, and a pair of the approximately L-shaped hinges affixed to opposite outer ends of the lens frames and adapted to hingedly connect the lens frames to a pair of temple arms, and a sunshade clip including a pair of sunshade lens frames to receive respective sunshade lenses, and a bridge to connect the sunshade lens frames to each other. A respective one of the hinges takes a multi-layered form having upper and lower connecting ribs defining an opening therebetween. To a rear surface of one of the upper and lower connecting ribs of the hinge is affixed a corresponding one of the magnets. The sunshade clip further comprises a pair of L-shaped magnet bars affixed at their front ends to opposite outer ends of the sunshade lens frames. Rear ends of the L-shaped magnet bars extend toward the spectacles.

### BACKGROUND OF THE INVENTION

1. Field of the Invention

The present invention relates to a spectacles and sunshade clip assembly having multi-layered hinges, and more particularly, to improved hinges of spectacles in which a respective one of the hinges has a decorative multi-layered form defined by two vertically spaced ribs and can allow a sunshade clip, having sunshade lens units and serving as sunglasses, to be detachably attached to the spectacles through attachment of a plurality of magnets provided at the hinges of the spectacles and corresponding magnet-mounting portions of the sunshade clip, resulting in a favorable appearance and convenient use of the spectacles and sunshade clip assembly.

2. Description of the Related Art

Conventionally, there have been disclosed various different configurations of a spectacles and sunshade clip assembly using magnets. However, the disclosed conventional configurations exhibit many problems in use.

For example, in order to obtain corresponding magnet-mounting structures of both the sunshade clip and the spectacles, the sunshade clip is conventionally designed to have a pair of bar-shaped protruding arm members configured to receive respective magnets, and the spectacles are designed so that corresponding magnets are mounted in a pair of hinges, which are configured to hingedly connect lens frames to temple arms.

The above described conventional configuration, however, has a problem in that the protruding arm members of the sunshade clip are exposed to the outside and tend to deteriorate the appearance of the sunshade clip as well as the spectacles in their assembled state, causing consumer apprehension to take a serious view of spectacle's aesthetic value. Further, the existence of the arm members, which should be separately formed with the hinges, may result in a difficulty in the construction of the spectacles and sunshade clip assembly.

Furthermore, the attachment of the sunshade clip to the spectacles requires careful matching of positions of the corresponding magnets, disabling rapid wearing of the sunshade clip. This may make it impossible for a wearer to rapidly respond to sudden brightness change possibly caused under particular conditions, such as for example, when the wearer drives a car.

### SUMMARY OF THE INVENTION

Therefore, the present invention has been made in view of the above problems, and it is an object of the present invention to provide a spectacles and sunshade clip assembly having decorative multi-layered hinges, which can allow a sunshade clip to be detachably attached to spectacles by means of magnets so as to prevent magnet-mounting portions of the sunshade clip from protruding outward by allowing the magnet-mounting portion of the sunshade clip to be hidden by the hinges of the spectacles in an assembled state of the spectacles and the sunshade clip, resulting in a favorable appearance and convenient use in the spectacles and sunshade clip assembly.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front perspective view illustrating the separated state of a sunshade clip and spectacles having multi-layered hinges in accordance with a first embodiment of the present invention;

FIG. 2a is a partially cut-away perspective view of the sunshade clip and the spectacles shown in FIG. 1;

FIG. 2b is a partially cut-away perspective view illustrating an alternative configuration of FIG. 2a;

FIG. 3 is a partially cut-away perspective view illustrating the assembled state of the sunshade clip and spectacles shown in FIG. 1;

FIG. 4 is a partially cut-away perspective view illustrating an alternative configuration of FIG. 1;

FIG. 5a is a partially cut-away perspective view illustrating a sunshade clip and spectacles having multi-layered hinges in accordance with a second embodiment of the present invention;

FIG. 5b is a partially cut-away perspective view illustrating an alternative configuration of FIG. 5a; and

FIG. 6 is a partially cut-away perspective view illustrating spectacles having multi-layered hinges in accordance with a third embodiment of the present invention.

### DESCRIPTION OF THE PREFERRED EMBODIMENTS

Now, a preferred embodiment of a spectacles and sunshade clip assembly having multi-layered hinges in accordance with the present invention will be described in detail with reference to the annexed drawings.

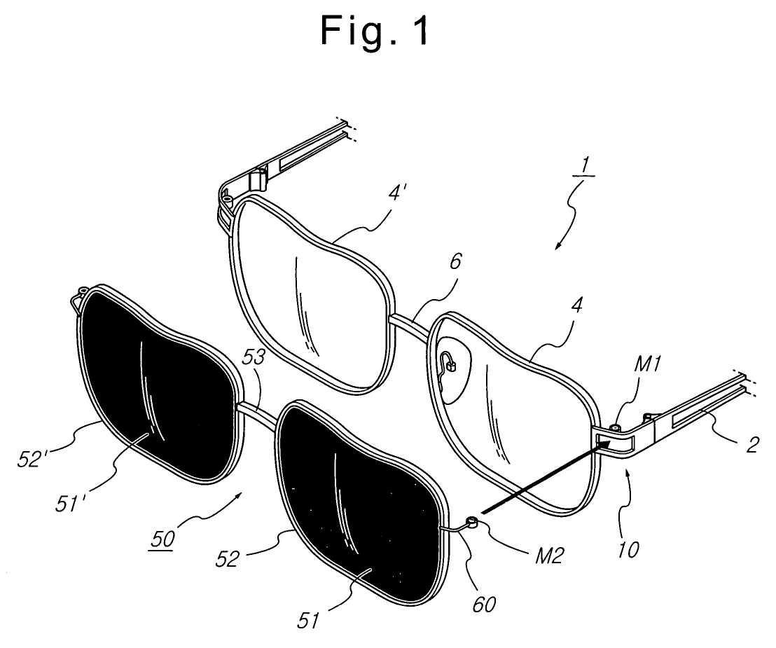

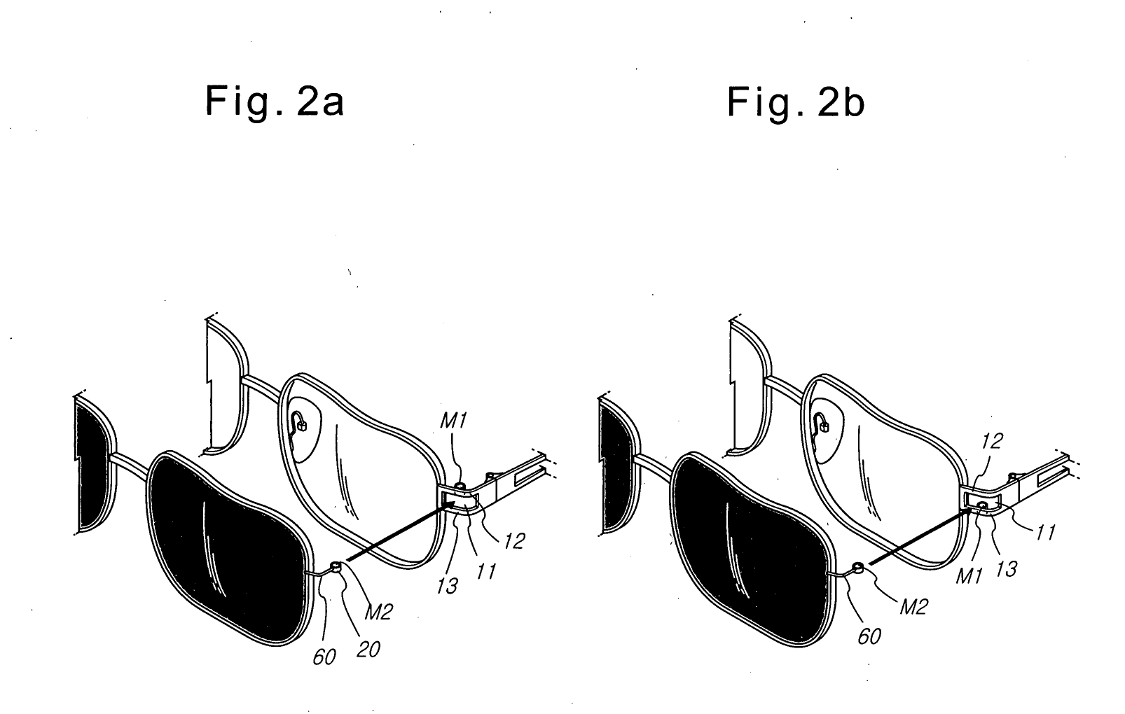

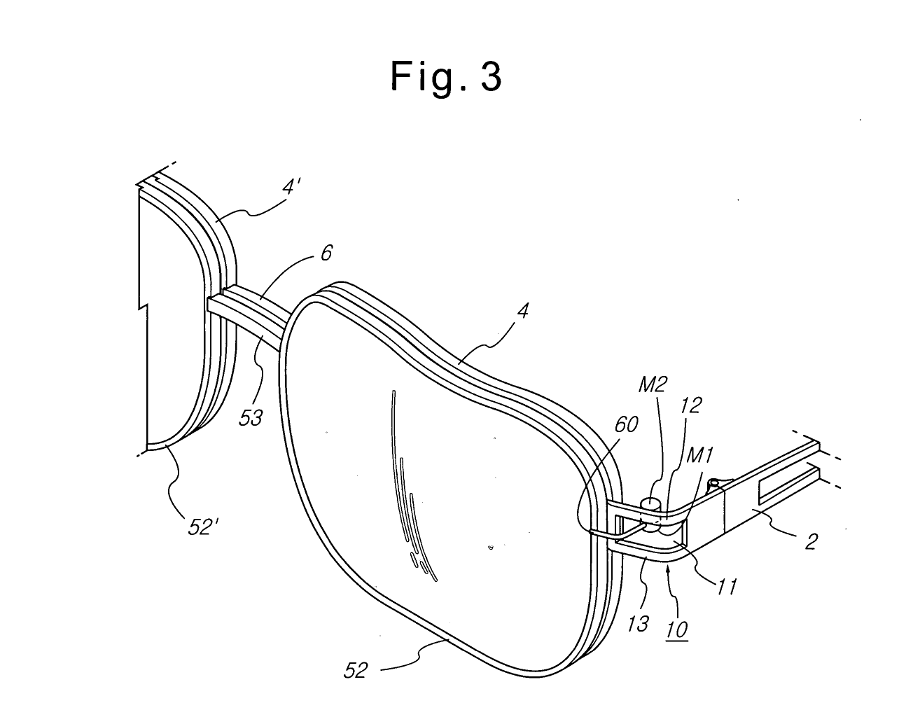

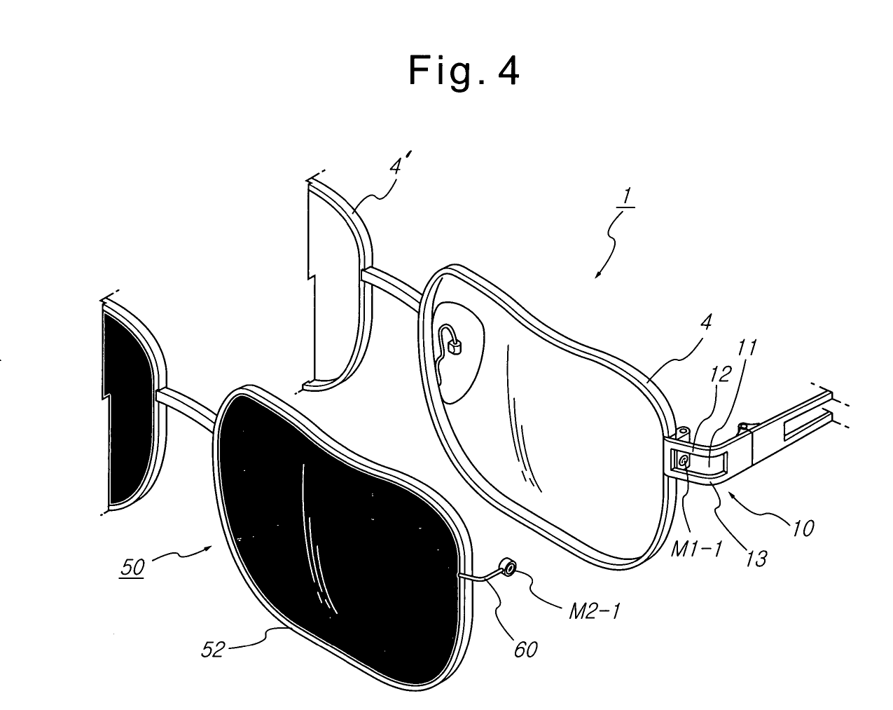

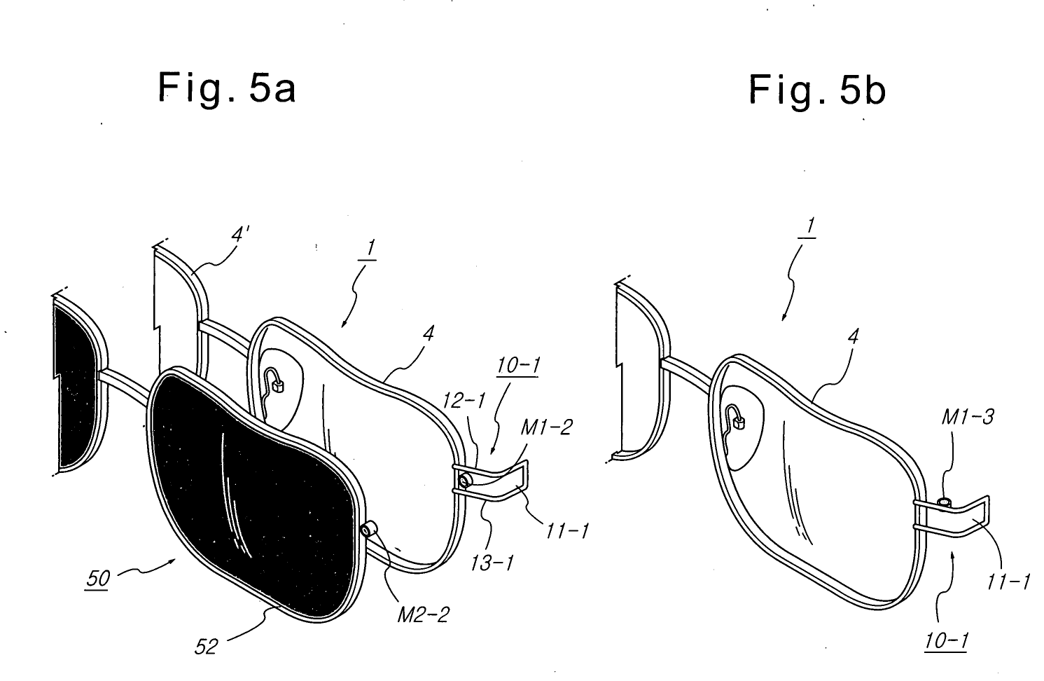

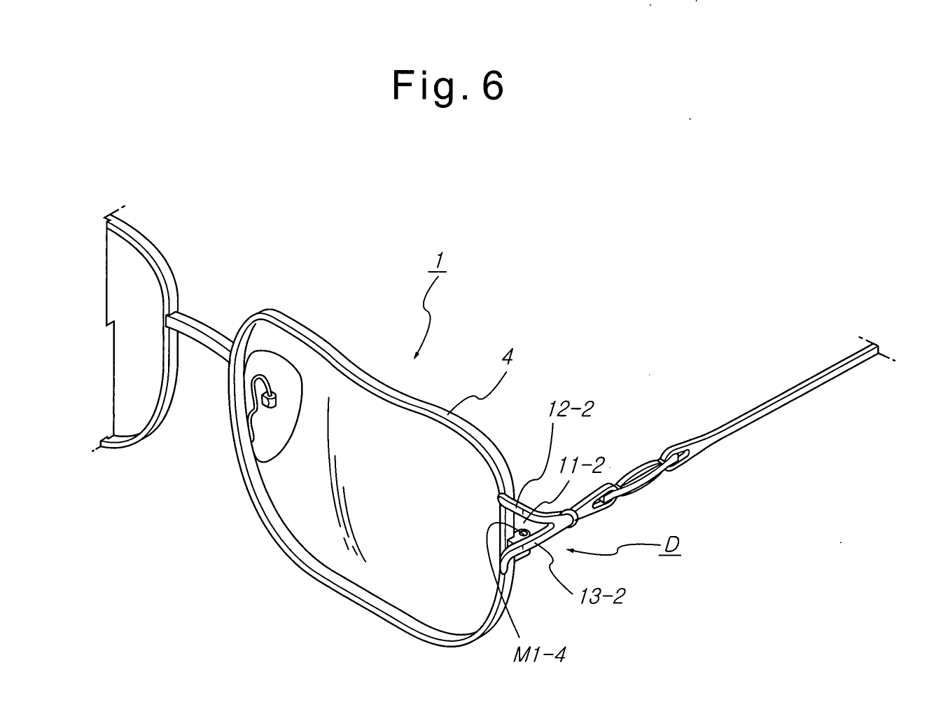

FIG. 1 is a front perspective view illustrating the separated state of a sunshade clip and spectacles having multi-layered hinges in accordance with a first embodiment of the present invention. FIGS. 2a and 2b are partially cut-away perspective views, respectively, illustrating different configurations of magnets of FIG. 1. FIG. 3 is a partially cut-away perspective view illustrating the assembled state of the sunshade clip and spectacles shown in FIG. 1, and FIG. 4 is a partially cut-away perspective view illustrating an alternative configuration of FIG. 1. FIGS. 5a and 5b are partially cut-away perspective views, respectively, illustrating a sunshade clip and spectacles having multi-layered hinges in accordance with a second embodiment of the present invention, and an alternative configuration thereof. FIG. 6 is a partially cut-away perspective view illustrating spectacles having multi-layered hinges in accordance with a third embodiment of the present invention.

It will be noted that the characteristic feature of the present invention is that a respective hinge of spectacles is defined by a pair of ribs vertically spaced apart from each other.

In the following description, since left and right sides of the sunshade clip are symmetrical, only one side will be designated by reference numerals and explained, except for lens units thereof. This same is true in the case of the spectacles. Further, the constituent elements of respective alternative embodiments corresponding to those of a first embodiment are designated by the same reference numerals.

The spectacles of the present invention, designated as reference numeral 1, take a generation configuration having lens frames, etc., made of metal, plastic, or the like. The spectacles 1 are detachably attached the sunshade clip of the present invention, designated as reference numeral 50, by means of magnets, achieving the spectacles and sunshade clip assembly.

Considering an exemplary general configuration shown in FIGS. 1, 2a and 3, the spectacles 1, of conventional metal-rimmed type, comprise a pair of approximately L-shaped hinges 10 affixed to opposite outer ends of a pair of lens frames 4 and 4′ and adapted to hingedly connect the lens frames 4 and 4′ to respective temple arms 2. The lens frames 4 and 4′ are also connected to each other by means of a bridge 6.

The hinges 10 of the spectacles 1 according to the present invention is configured in such a fashion that each of the hinges 10 has a pair of upper and lower connecting ribs 12 and 13, defining an opening 11 therebetween, to thereby achieve a multi-layered shape.

That is, the technical idea of the present invention is applicable only to the spectacles having such a multi-layered hinge 10, and such a multi-layered design is one of various modified designs of spectacles obtained in the aesthetic point of view.

In a first embodiment of the present invention, a respective one of the hinges 10 of the spectacles 1 is provided with a magnet M1 in such a fashion that the magnet M1 is affixed to a rear surface of one of the upper and lower connecting ribs 12 and 13, defining the opening 11, of the corresponding hinge 10.

The magnet M1 is made of a highly magnetically induced material, and is fixedly inserted in a cylindrical receiving member 20.

Meanwhile, the sunshade clip 50, to be detachably attached to the spectacles 1, is configured to have the same outer contour as that of the spectacles 1, and comprises a pair of sunshade lens frames 52 and 52′ to receive respective sunshade lenses 51 and 51′, and a bridge 53 to connect the sunshade lens frames 52 and 52′ to each other.

The sunshade clip 50 further comprises a pair of L-shaped magnet bars 60 integrally affixed at their front ends to opposite outer ends of the sunshade lens frames 52 and 52′. In this case, rear ends of the L-shaped magnet bars 60 extend toward the spectacles 1, and to the rear ends of the magnet bars 60 are affixed magnets M2, respectively.

The magnets M2 of the sunshade clip 50, inserted in and attached to the magnet bars 60, are freely selectable from among various shapes of conventional magnets made of highly magnetically induced material. Further, it is allowable that the magnet bars 60 are formed as magnetized elements. In preferred embodiments of the present invention shown in the annexed drawings, the magnets M2 of the sunshade clip 50 are formed as disk-shaped inserts and are inserted in respective cylindrical receiving members 61.

With such a configuration as stated above, in an assembled state of the sunshade clip 50 and the spectacles 1, the magnets M1, affixed to the rear surfaces of the upper or lower connecting ribs 12 or 13 of the hinges 10, are detachably attached to the corresponding magnets M2 affixed to the rear ends of the magnet bars 60.

Referring to FIG. 3, there is shown the assembled state of the spectacles 1 and the sunshade clip 50 wherein the magnet M2 of the sunshade clip 50 passes through the opening 11 defined in the hinge 10 of the spectacles 1 and is attached to the corresponding magnet M1 of the spectacles 1. As shown in FIG. 3, as the magnet bar 60 of the sunshade clip 50 passes through the opening 11 of the spectacles 1 so as to be positioned inward to the hinge 10, the sunshade clip 50 has no outwardly protruding portion exposed to the outside in the assembled state of the spectacles 1 and the sunshade clip 50, resulting in a favorable appearance of the spectacles and sunshade clip assembly.

Here, as will be clearly understood with reference to FIGS. 2a and 2b, the magnet M1 can be selectively mounted to one of the upper and lower connecting ribs 12 and 13 defining the opening 11 of the hinge 10.

Referring to FIG. 4 illustrating an alternative configuration of FIG. 1, instead of being mounted to one of the upper and lower connecting ribs 12 and 13 defining the opening 11 of the hinge 10, a magnet M1-1 is affixed to an outer end of a respective one of the lens frames 4 and 4′. In this case, a magnet M2-1 of the sunshade clip 50 is affixed to the magnet bar 60 so that it faces the corresponding magnet M1-1.

Considering now a second embodiment of the present invention with reference to FIGS. 5a and 5b, a hinge 10-1 provided at either outer end of the spectacles 1 takes a bent wire form having no plane portion, and consists of a pair of upper and lower connecting wires 12-1 and 13-1 defining an opening 11-1 therebetween. In the present embodiment, a magnet M1-2 of the spectacles 1 may be affixed to an outer end of a corresponding one of the lens frames 4 and 4′ as shown in FIG. 5a, or a magnet M1-3 may be selectively affixed to one of the upper and lower connecting wires 12-1 and 13-1 of the corresponding hinge 10-1 as shown in FIG. 5b. In this case, a magnet M2-2 of the sunshade clip 50 is affixed at an appropriate position of respective one of the sunshade lens frames 52 and 52′ so as to face the magnet M1-2 or M1-3.

Considering a third embodiment of the present invention with reference to FIG. 6, hinges D of the spectacles 1 are configured to reinforce their decorative function. For this, each of the hinges D consists of upper and lower connecting bars 12-2 and 13-2 defining a triangular opening 11-2 therebetween. Such decorative hinges D are advantageously applicable to women's spectacles. In this case, similarly, a magnet M1-4 of the spectacles 1 may be affixed to one of the upper and lower connecting bars 12-2 and 13-2 or may be affixed to an outer end of a respective one of the lens frames 4 and 4′ to thereby achieve the same operational effects as the first and second embodiments.

As apparent from the above description, the present invention provides a spectacles and sunshade clip assembly having multi-layered hinges, which can prevent magnet-mounting portions of the sunshade clip, namely, magnet bars, from being exposed to the outside in an assembled state of the spectacles and the sunshade clip, resulting in a favorable appearance of the spectacles and sunshade clip assembly. Further, according to the present invention, since the magnet bars of the sunshade clip can be easily inserted through openings defined in the respective multi-layered hinges of the spectacles and the magnets of the sunshade clip can be readily affixed to the magnets of the spectacles, it is possible to achieve the rapid wearing of the sunshade clip and increase the convenience of use thereof.

Although the preferred embodiment of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spectacles and sunshade clip assembly comprising: spectacles including a pair of lens frames connected to each other by means of a bridge, and a pair of the approximately L-shaped hinges affixed to opposite outer ends of the lens frames and adapted to hingedly connect the lens frames to a pair of temple arms; and a sunshade clip configured to have the same outer contour as that of the spectacles and including a pair of sunshade lens frames to receive respective sunshade lenses, and a bridge to connect the sunshade lens frames to each other, the sunshade clip being detachably attachable to the spectacles by means of magnets,
wherein a respective one of the hinges takes a multi-layered form having upper and lower connecting ribs defining an opening therebetween, to a rear surface of one of the upper and lower connecting ribs of the hinge being affixed a corresponding one of the magnets, and
wherein the sunshade clip further comprises a pair of L-shaped magnet bars affixed at their front ends to opposite outer ends of the sunshade lens frames, rear ends of the L-shaped magnet bars extending toward the spectacles, to the rear end of the respective magnet bars being affixed a corresponding one of the magnets.

2. The assembly as set forth in claim 1, wherein the magnets of the spectacles are affixed to opposite outer ends of the respective lens frames, instead of being affixed to the upper or lower connecting ribs of the respective hinges, and
wherein the magnets of the sunshade clip are affixed to the respective magnet bars to face the corresponding magnets of the spectacles.

3. The assembly as set forth in claim 1, wherein a respective one of the hinges has a bent wire form consisting of upper and lower connecting wires defining an opening therebetween.

4. The assembly as set forth in claim 1, wherein the hinges of the spectacles are decorative hinges consisting of decorative elements defining an opening having a particular form therebewteen.
